(19) United States
(12) Patent Application Publication
(10) Pub. No.: US 2022/0220967 A1
(43) Pub. Date: Jul. 14, 2022

(54) AUXILIARY PROPELLING SET UP FOR MAN-POWERED VEHICLES

(71) Applicant: National Taiwan University, Taipei (TW)

(72) Inventors: Ching-Fuh Lin, Taipei (TW); Ta-Jung Lin, Taipei City (TW)

(21) Appl. No.: 17/481,886

(22) Filed: Sep. 22, 2021

(30) Foreign Application Priority Data
Jan. 14, 2021 (TW) 110101401

(51) Int. Cl. F04D 25/06; B62J 45/412; B62M 6/90; B62J 45/20; F04D 19/00

(52) U.S. Cl. CPC F04D 25/0673; B62J 45/412; F04D 19/002; B62J 45/20; B62M 6/90

(57) ABSTRACT

An auxiliary power for man-powered vehicles includes an air propelling device and a control system. The air propelling device is mounted on a man-powered vehicle for discharging air toward the back of the man-powered vehicle. Due to the reaction force, the man-powered vehicle is provided with forward thrust. The control system connects to the air propelling device in a wired or wireless manner to control the amount of air discharged by the air propelling device.

### CROSS-REFERENCE TO RELATED APPLICATIONS

The entire contents of Taiwan Patent Application No. 110101401, filed on Jan. 14, 2021, from which this application claims priority, are expressly incorporated herein by reference.

### BACKGROUND OF THE INVENTION

### 1. Field of the Invention

The present invention relates to an auxiliary propelling set up for man-powered vehicles.

### 2. Description of Related Art

Bicycles or man-powered vehicles provide convenience for human mobility. They are faster than walking, so shortening the transportation time, but slower than mobiles and hence safer than cars and motorcycles. However, the traditional bicycles need people to supply power, and people will feel tired if pedaling a bicycle for a long time. Therefore, electric bicycles or electric vehicles of low speeds are gaining popularity. In addition, with the environmental requirements of pollution-free transportation tools, current trend is to replace fossil fuels with electric manners.

Most of currently electric bicycles employ a motor to drive their wheels, and this manner requires significant amendments in the power mechanism of the bicycle. For example, Taiwan patent TW202010673A discloses an electric bicycle, which includes a driving unit that transmits driving force to the front or rear wheel. The force applied on the pedal by the rider combining with the driving force from the driving unit (including a motor) is transmitted to the front wheel or the rear wheel, thereby driving the electric bicycle to travel. Due to a different mechanism, people must purchase a new electric bicycle, which makes the original bicycle redundant and wasteful.

In addition, the wheel is linked with the motor in the design of the electric bicycle, so if the wheel does not rely on electric driving, it can only be driven by human power. Compared with ordinary bicycles, riders need to exert more power to drive electric bicycles. This makes most electric bicycles only suitable for electric drive and difficult to use as ordinary bicycles.

In addition, if the battery is dead in the outdoors, it is necessary to use human power to drive the electric bicycle. As mentioned above, it is inconvenient for the rider to spend more effort to drive the electric bicycle. And because of the fear that the battery is dead, it reduces the user's desire to use electric bicycles.

### SUMMARY OF THE INVENTION

According to one aspect of the present invention, an auxiliary power for a man-powered vehicle includes an air propelling device and a control system. The air propelling device is mounted on the man-powered vehicle and is used to discharge air toward the back of the man-powered vehicle, such that the man-powered vehicle moves forward by a reaction force of the discharged air. The control system is connected to the air propelling device through a wired or wireless manner to control the amount of air discharged by the air propelling device.

According to another aspect of the present invention, the auxiliary power further includes an air balancing device, which discharges air upward or downward the man-powered vehicle at the left and right sides of the man-powered vehicle. Such that the man-powered vehicle can be balanced by controlling the amount of air discharged from the left and right sides.

According to another aspect of the present invention, the auxiliary power includes an auxiliary device and a control system. The auxiliary device is mounted on the man-powered vehicle and includes a converting mechanism and a plurality of auxiliary wheels. The auxiliary wheels are connected to the converting mechanism, and the converting mechanism can selectively position the auxiliary wheels in contact with the ground, so that the man-powered vehicle is driven by the auxiliary wheels. The control system connects to the auxiliary device in a wired or wireless manner so as to control the rotational speed of the auxiliary wheels.

The auxiliary power provided by the present invention does not affect the existing driving mechanism of the man-powered vehicle and is separated from the user's driving force, so the user can easily pedal the man-powered vehicle as usual. The two driving forces can be used in any ratio, which is much more convenient than traditional electric bicycles.

In addition, the auxiliary power provided by the present invention can be easily and quickly mounted on the man-powered vehicle, such that a traditional man-powered vehicle can be quickly transformed into an electric/man-powered vehicle without needing to purchase a new electric vehicle. When the battery is exhausted, the vehicle can rely on human power, or the auxiliary power can be quickly removed to transform the vehicle into a traditional man-powered vehicle.

### BRIEF DESCRIPTION OF THE DRAWINGS

FIG. 1 is a block diagram showing an auxiliary power for man-powered vehicles in accordance with an embodiment of the present invention.

FIGS. 2A and 2B are perspective views with different viewing angles, showing an air propelling device in accordance with an embodiment of the present invention.

FIG. 2C is a perspective view showing an air propelling device in accordance with another embodiment of the present invention.

FIG. 2D is a perspective view showing an air propelling device in accordance with another embodiment of the present invention.

FIG. 3 is a block diagram showing a control system of an auxiliary power in accordance with an embodiment of the present invention.

FIG. 4 is a block diagram showing a control system of an auxiliary power in accordance with another embodiment of the present invention.

FIG. 5 is a block diagram showing a control system of an auxiliary power in accordance with another embodiment of the present invention.

FIG. 6 is a block diagram showing an auxiliary power in accordance with another embodiment of the present invention.

FIG. 7 is a rear view showing an air balancing device that is mounted on a man-powered vehicle in accordance with an embodiment of the present invention.

FIG. 8 is a schematic perspective view showing an air propelling device in accordance with another embodiment of the present invention.

FIG. 9 illustrates an auxiliary power that is mounted on a man-powered vehicle in accordance with an embodiment of the present invention.

FIGS. 10A and 10B are schematic diagrams showing an auxiliary power for man-powered vehicles in accordance with another embodiment of the present invention.

### DETAILED DESCRIPTION OF THE PREFERRED EMBODIMENT

Reference will now be made in detail to those specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not described in detail in order not to unnecessarily obscure the present invention. While drawings are illustrated in detail, it is appreciated that the quantity of the disclosed components may be greater or less than that disclosed, except where expressly restricting the amount of the components. Wherever possible, the same or similar reference numbers are used in drawings and the description to refer to the same or like parts.

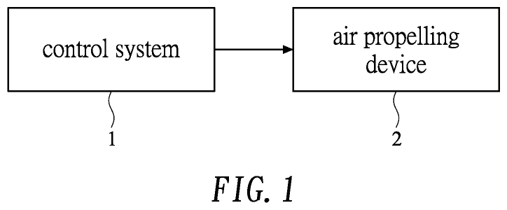

FIG. 1 is a block diagram showing an auxiliary power for man-powered vehicles in accordance with an embodiment of the present invention. Referring to FIG. 1, the auxiliary power for man-powered vehicles includes a control system 1 and an air propelling device 2. The control system 1 and the air propelling device 2 are mounted on a man-powered vehicle (not shown). The air propelling device 2 can discharge air toward the rear of the man-powered vehicle, such that the man-powered vehicle moves forward by a reaction force of the discharged air. The control system 1 connects to the air propelling device 2 in a wired or wireless manner so as to control the amount of air discharged by the air propelling device 2.

In this context, “man-powered vehicles” refers to any vehicle that is driven by the force of the rider's feet on a pedaling mechanism. Typical man-powered vehicles may direct to a bicycle or tricycle. Man-powered vehicles are usually two-wheeled, but they can also be three-wheeled, single-wheeled, or multi-wheeled.

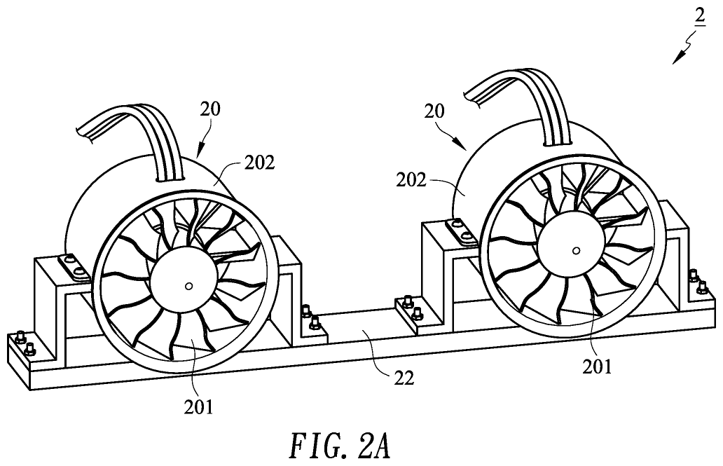

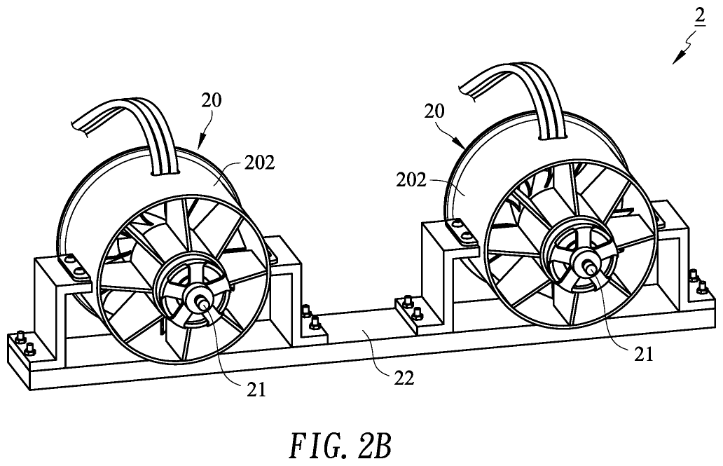

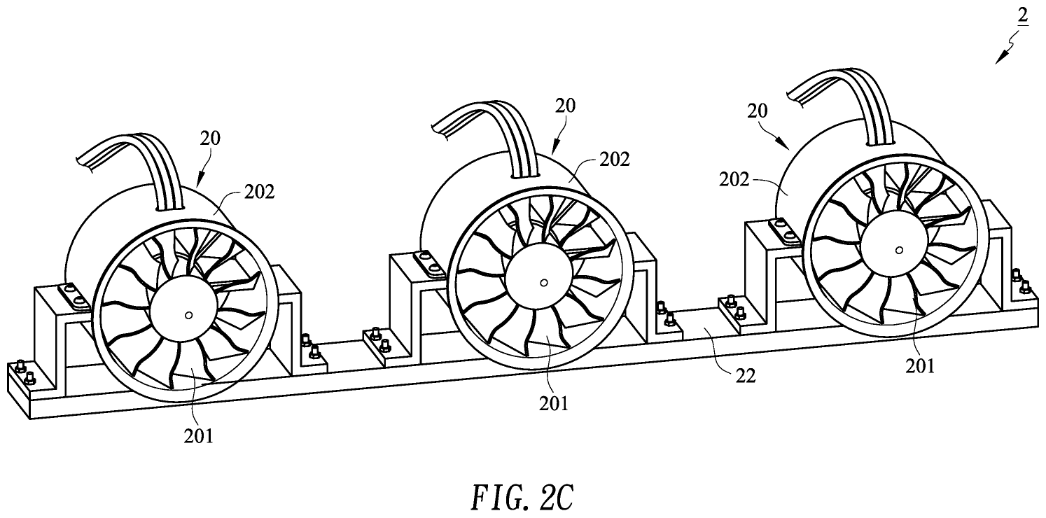

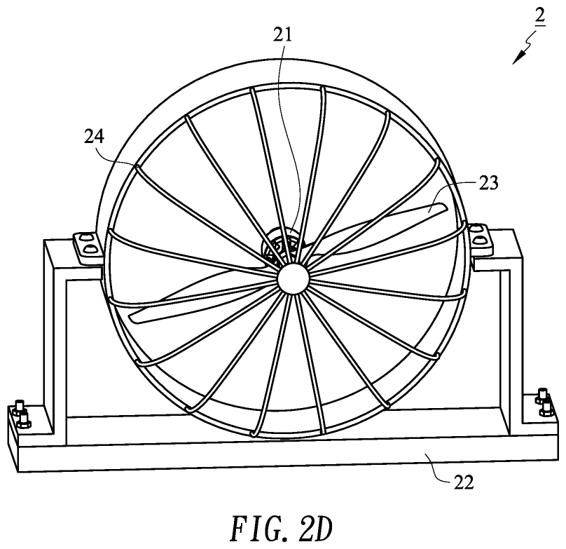

FIGS. 2A and 2B are perspective views with different viewing angles, showing the air propelling device 2 in accordance with an embodiment of the present invention. Referring to FIGS. 2A and 2B, in this embodiment, the air driving device 2 includes one or more guide fan assemblies 20 and one or more corresponding motors 21. Each guide fan assembly 20 includes a propeller 201 and a duct 202. The propeller 201 is arranged within the duct 202, and the number of guide fan assemblies 20 corresponds to the number of motors 21. Each motor 21 is connected to the corresponding propeller 201 and can drive the propeller 201 to rotate. A respective protective cover or housing (not shown) may be provided to cover each motor 21 so that the propellers 201 will not be directly touched by the users. The guide fan assemblies 20 may be mounted on the man-powered vehicle through a frame 22, which is not limited to the structure shown in FIGS. 2A and 2B. In this embodiment, the number of the guide fan assemblies 20 and the number of the motors 21 is for example but not limited to two each. In one embodiment the number of the guide fan assemblies 20 and the motors 21 is four each, two rows respectively arranged up and down and two in each row. FIG. 2C shows another embodiment, where the number of the guide fan assemblies 20 and the number of motors 21 is three each.

FIG. 2D shows an air propelling device 2 in accordance with another embodiment of the present invention. In this embodiment, the air propelling device 2 includes one or more propellers 23 and one or more motors 21. FIG. 2D only shows one propeller 23 and one motor 21, and the number of them can be multiple. The propeller 23 may be arranged in a protective cover 24. The number of propellers 23 corresponds to the number of motors 21. Each motor 21 is connected to one corresponding propeller 23 and drives the propeller 23 to rotate. A protective housing (not shown) may be provided to cover the motor. The protective cover 24 is mounted on the man-powered vehicle through a fixing frame 22, which may have a structure different from FIG. 2D. In one embodiment, the diameter of the propeller 23 is 18 inches.

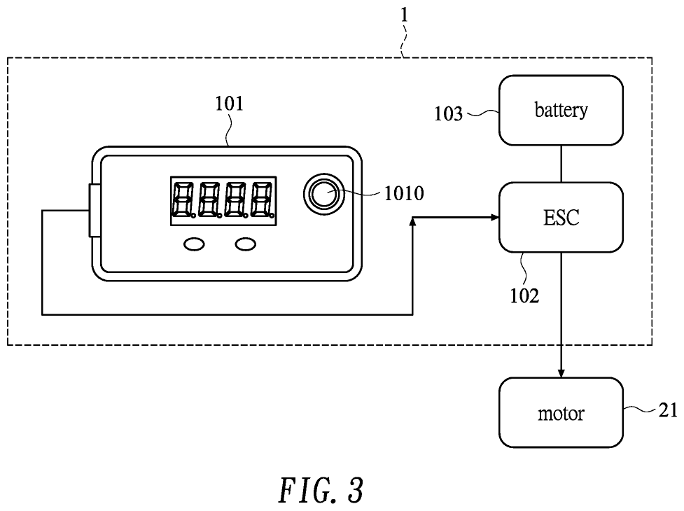

FIG. 3 is a block diagram showing a control system 1 of an auxiliary power in accordance with an embodiment of the present invention. As shown in FIG. 3, in this embodiment, the control system 1 includes a controller 101, one or more electronic speed controllers (ESC) 102, and a battery 103. The electronic speed controller 102 is also referred as electronic speed control (ESC), and the number of electronic speed controllers 102 can correspond to the number of motors 21. Each electronic speed controller 102 is connected to the controller 101, the battery 103, and the corresponding motor 21. In some embodiments, the battery 103 may be a lithium battery, a solar-cell module, etc. In some embodiments, the battery 103 can be charged with a solar-cell module. In some embodiments, the battery 103 also provides power required by other components, such as the controller 101. Each electronic speed controller 102 receives the control signal provided by the controller 101 and converts it into current for the motor 21 so as to control a rotational speed of the corresponding motor 21. In some embodiments, the control signal provided by the controller 101 is a pulse-width modulation (PWM) signal. In some embodiments, the control signal provided by the controller 101 is a pulse-position modulation signal. In one embodiment, a digital servo tester, model no. 042766 sold by HJ Company, is employed as the controller 101. The pulse width output by the controller 101 may range from 500 us to 2500 μs. And in one embodiment, it ranges from 800 μs to 2200 μs. The user can regulate the pulse width of the control signal by operating a knob 1010 of the controller 101. The higher (wider) the pulse width of the control signal, the faster of the rotational speed of the motor 21 or the vice versa.

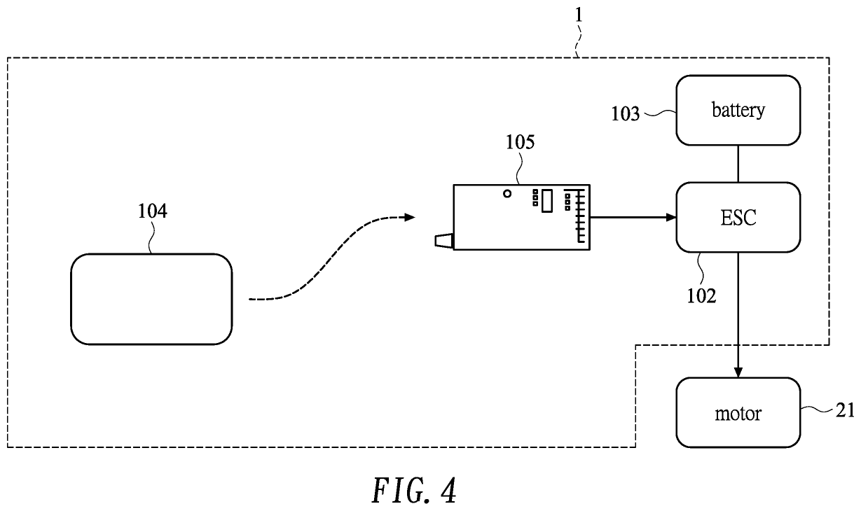

FIG. 4 is a block diagram showing a control system 1 of an auxiliary power in accordance with another embodiment of the present invention. As shown in FIG. 4, in this embodiment, the control system 1 includes a remote controller 104, a receiver 105, one or more electronic speed controllers 102, and a battery 103. The number of electronic speed controllers 102 may correspond to the number of motors 21. Each electronic speed controller 102 is connected to the receiver 105, the battery 103, and the corresponding motor 21. The receiver 105 wirelessly receives a control signal e.g., a pulse width modulation (PWM) signal provided by the remote controller 101, and transmits the control signal to the electronic speed controller 102. Each electronic speed controller 102 receives the control signal provided by the receiver 105 through a wire or circuit and converts the control signal into a current for the corresponding motor 21 so as to control a rotational speed of the corresponding motor 21. The user can regulate the pulse width of the output control signal by operating a mechanism, e.g., a joystick or a knob (not shown) mounted on the remote controller 101. The higher (wider) the pulse width of the control signal, the faster of the rotational speed of the motor 21.

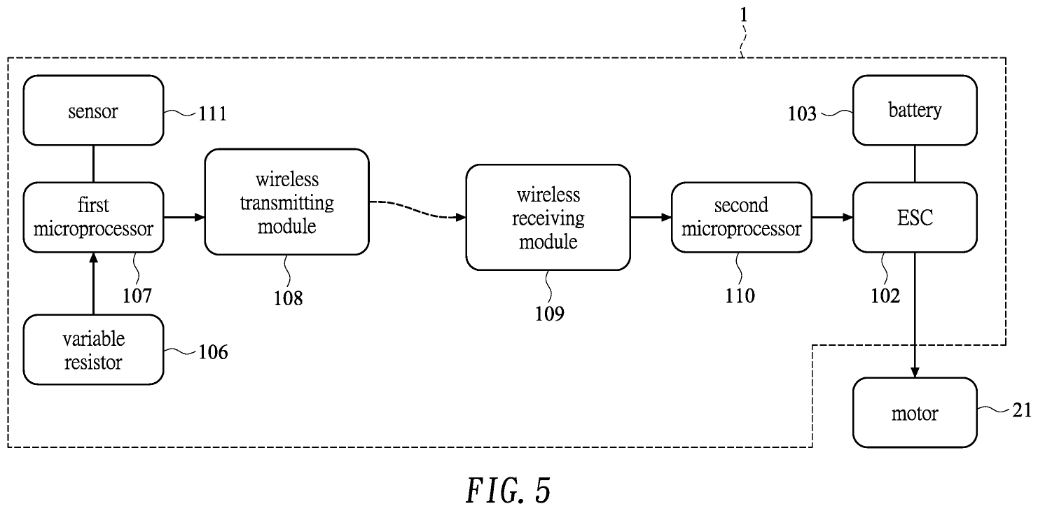

FIG. 5 is a block diagram showing a control system 1 of an auxiliary power in accordance with another embodiment of the present invention. Referring to FIG. 5, in this embodiment, the control system 1 includes a variable resistor 106, a first microprocessor 107, a wireless transmitting module 108, a wireless receiving module 109, a second microprocessor 110, one or more electronic speed controllers 102 and corresponding batteries 103. The variable resistor 106 may be a rotary potentiometer or a linear slide potentiometer. The user rotates or slides the variable resistor 106 to change its output voltage. The first microprocessor 107 is connected to the variable resistor 106 to receive the voltage output by the variable resistor 106 and convert it into a control signal. The wireless transmitting module 108, such as a Bluetooth, Wi-Fi transmission module, or other types of RF module, transmits the control signal in a wireless manner. The wireless receiving module 109, such as a Bluetooth, Wi-Fi, or other types of RF receiving module, receives the control signal. The second microprocessor 110 is connected to the wireless receiving module 109 to receive the control signal. The second microprocessor 110 may convert the control signal into a pulse-width modulation (PWM) signal. The number of electronic speed controllers 102 may correspond to the number of motors 21. Each electronic speed controller 102 receives a pulse width modulation (PWM) signal provided by the second microprocessor 110 through a wire or circuit and converts it into a current for the corresponding motor 21 so as to control the rotational speed of the corresponding motor 21. In one embodiment, the wireless receiving module 109 and the second microprocessor 110 of FIG. 5 can be replaced by the receiver 105 of FIG. 4.

In one embodiment, the control system 1 shown in FIG. 5 further includes one or more sensors 111, such as accelerometers and gyroscopes, for detecting e.g., acceleration, attitude of the man-powered vehicle. The one or more sensors 111 may include a sensor for detecting the torque or rotational speed of the cranks of the man-powered vehicle, and a sensor for detecting obstacles. One or more sensors can transmit the detected or measured signal to the first microprocessor 111 (or the second microprocessor), which outputs a control signal according to the detected or measured signal to achieve intelligent control. In one embodiment, for example, the sensor 111 detects that the man-powered vehicle is climbing. In response thereto, a control signal is outputted to increase the amount of air discharged by the air propelling device 2 so as to increase the rotational speed of the motor 21. In one embodiment, the sensor 111 detects a potentially dangerous event, e.g., an obstacle being detected within a certain distance in front of the man-powered vehicle. In response thereto, a control signal is outputted to reduce the amount of air discharged by the air propelling device 2, so as to reduce the rotational speed of the motor 21. In one embodiment, the one or more sensors 111 can with voice control. In this case, the user may regulate the speed of the man-powered vehicle through voice control. For example, if the user inputs “faster” through voice, the first microprocessor 107 outputs a control signal to increase the rotational speed of the motor 21.

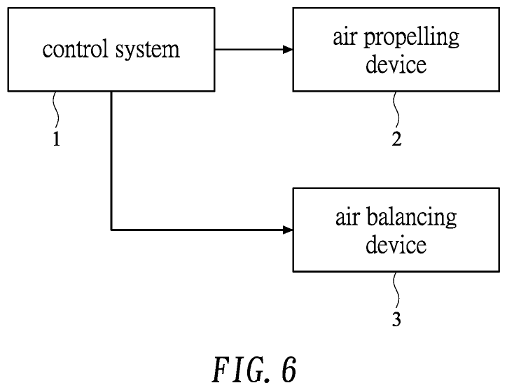

FIG. 6 is a block diagram showing an auxiliary power for man-powered vehicles in accordance with another embodiment of the present invention. Referring to FIG. 3, in addition to the control system 1 and the air propelling device 2, the auxiliary power further includes an air balancing device 3. The air balancing device 3 is arranged at a left side and a right side of the man-powered vehicle to discharge air upward or downward the man- powered vehicle, so as to balance the man-powered vehicle by controlling the amount of air discharged from the left side and the right. The direction of air discharged by the air balancing device 3 can be upward or downward. The amount of air discharged on the left side of the man-powered vehicle may be different from the amount of air discharged on the right side of the man-powered vehicle.

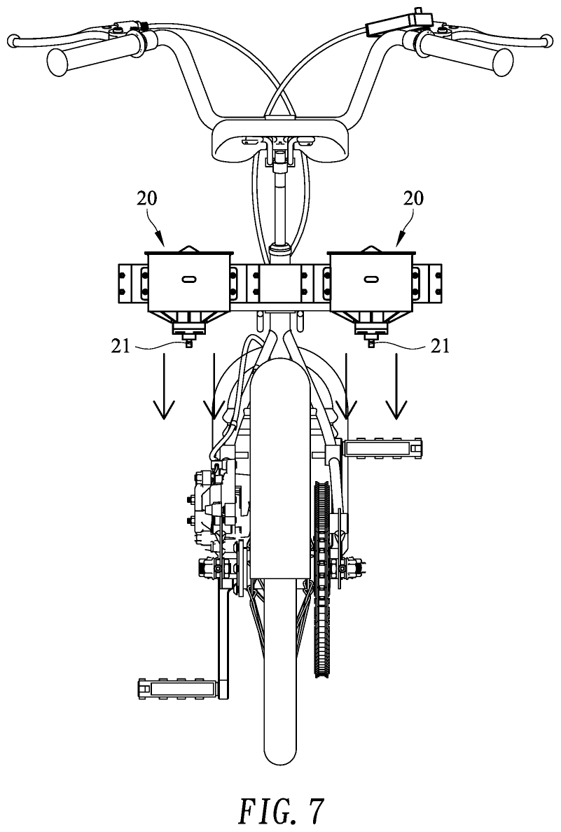

FIG. 7 is a rear view showing an air balancing device 3 that is mounted on a man-powered vehicle, e.g., a bicycle, in accordance with an embodiment of the present invention. In this embodiment, the air balancing device 3 includes a plurality of guide fan assemblies 20 and a plurality of corresponding motors 21 as shown in FIGS. 2A and 2B. The guide fan assembly 20 may be mounted on the bicycle through a fixing mechanism, which may have a structure different from the structure shown in FIG. 7. The number of the guide fan assemblies 20 and the motors 21 are for example but not limited to two each, and the guide fan assemblies 20 and the motors are evenly arranged on the left and right sides of the bicycle. In this embodiment, air enters each guide fan assembly 20 and is discharged in the direction of the ground. For instance, if the sensor detects that the bicycle is leaning to the left with respect to the direction of travel, the control system 1 such as the first microprocessor 107, outputs a control signal to increase the rotational speed of the motor 21 on the left side of the bicycle, and/or to decrease the rotational speed of the motor 21 on the right side of the bicycle. In one embodiment, the rotational directions of the guide fan assemblies 20 on the left and right sides may be the same or opposite. For example, the guide fan assembly 20 on the left rotates counterclockwise, and the guide fan assembly 20 on the right rotates clockwise.

In another embodiment, the air balancing device 3 includes a plurality of air propelling devices 2 as shown in FIG. 2D. The air balancing device 3 includes a plurality of motors 21 and a plurality of propellers 23 which are evenly arranged on the left and right sides of the man-powered vehicle. The motors 21 correspond to the propellers 23, and each motor 21 is connected to one corresponding propeller 23 and drives the corresponding propeller 23 to rotate.

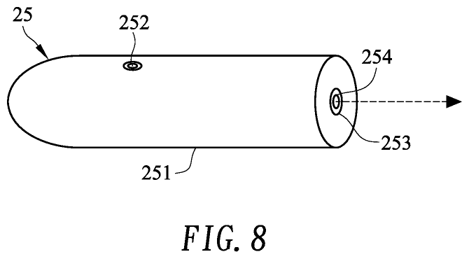

FIG. 8 is a schematic perspective view showing an air propelling device 2 according to another embodiment of the present invention. Referring to FIGS. 2A and 2B, in this embodiment, the air propelling device 2 includes one or more compressed air devices 25. Each compressed air device 25 may include a gas container 251, an air inlet 252, an air outlet 253, and a control valve 254. The one or more compressed air devices 25 are mounted on a man-powered vehicle through a fixing mechanism, and are capable of discharging air toward the rear of the man-powered vehicle. The container 251 is used to contain a compressed air, and its pressure may range between 50 atm and 200 atm. The air inlet 252 is used to inject the compressed air into the container 251. In one embodiment, the air inlet 252 is omitted. The air outlet 253 is used to discharge the compressed air. Through electronic or mechanical control, the control valve 2 is used to control the amount of the compressed air to be discharged. In one embodiment, the user varies the size of the flow passage of the control valve 2 through the control system 1 to control the amount of the discharged air. In one embodiment, the number of compressed air devices 25 is for example but not limited to two. In another embodiment, the number of compressed air devices 25 is four.

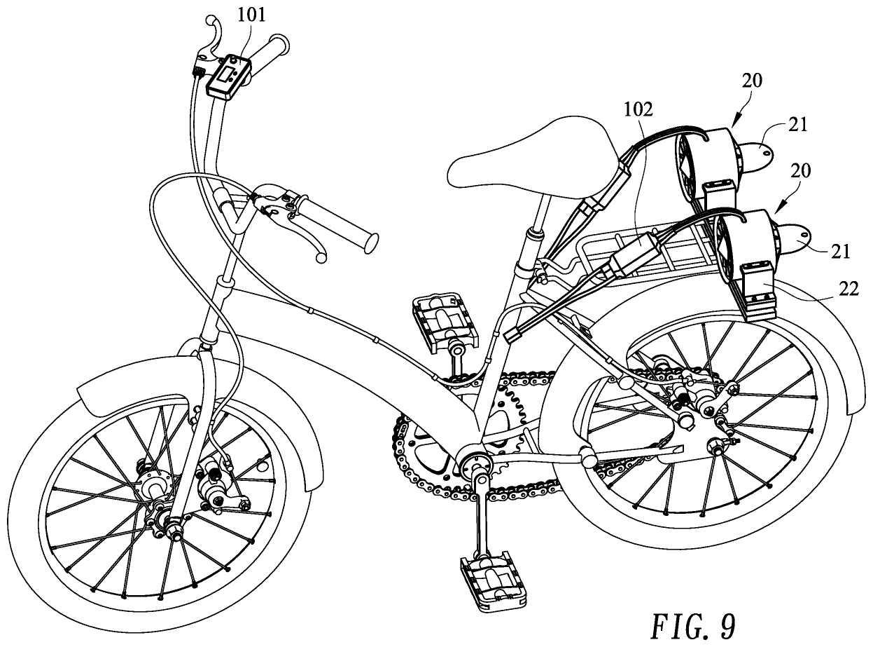

FIG. 9 illustrates that the auxiliary power in accordance with an embodiment of the present invention is applied to a bicycle. In this embodiment, the air propelling device 2 includes two guide fan assemblies 20 and two motors 21, and the control system 1 of FIG. 3 is adopted. The guide fan assemblies 20 are mounted on the rear seat of the bicycle, but they can also be mounted on other parts of the bicycle. The guide fan assemblies 20 may be mounted in any position of the bicycle as long as they do not affect people's movements and where there is airflow through the guide fan assemblies 20.

In one embodiment, the air balancing device 3 shown in FIG. 6 includes a plurality of compressed air devices 25 shown in FIG. 8. The compressed air devices 3 are evenly arranged on the left and right sides of the man-powered vehicle, and discharge air upward or downward the man-powered vehicle. By controlling the amount of air discharged from the left side and the right side, the man-powered vehicle is balanced.

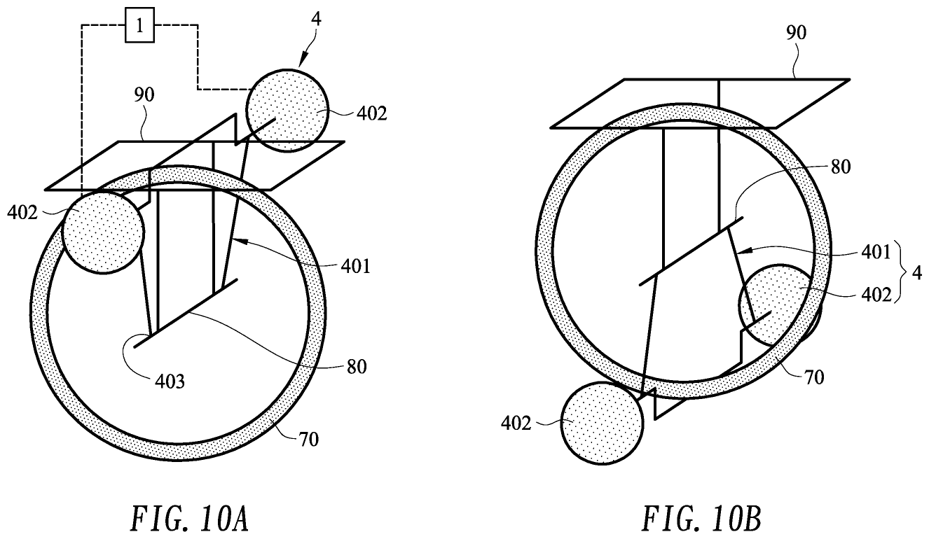

FIGS. 10A and 10B are schematic diagrams showing an auxiliary power for man-powered vehicles in accordance with another embodiment of the present invention. In this embodiment, the auxiliary power for man-powered vehicles includes an auxiliary device 4 and the previously described control system 1. The auxiliary device 4 is mounted on a man-powered vehicle, e.g., a bicycle, and includes a converting mechanism 401 and a pair or a plurality of auxiliary wheels 402 connected to the converting mechanism 401. The user can switch the position of the auxiliary wheels 402 through the switching mechanism 401. As shown in FIG. 10A, the converting mechanism 401 may have two pivot ends 403 pivoted to an axle 80 of a rear wheel 70 of the man-powered vehicle. Through the pivoting of the pivot ends 403, the auxiliary wheels 402 are located on the rear seat 90 (or behind the rear wheel) of the bicycle, so that the bicycle is driven by the original rear wheel 70 as usual. Alternatively, as shown in FIG. 10B, the converting mechanism 401 is pivoted so that the auxiliary wheels 402 are in contact with the ground to replace the original rear wheel 70, and the bicycle is driven by the auxiliary wheels 402. The control system 1 is connected to the auxiliary wheels 402 in a wired or wireless manner to control the rotational speed of the auxiliary wheels 402. The details of the control system 1 have been previously described in FIGS. 3-5, for example. In one embodiment, each auxiliary wheel 402 can be connected to one corresponding motor 21, which can be controlled through one corresponding electronic speed controller 102, and a controller 101 provide control signals to the electronic speed controller 102 so as to control a rotational speed of the motor 21 and the auxiliary wheel 402.

In some embodiments of the present invention the converting mechanism 401 may differ from the structure shown in FIGS. 10A and 10B. For example, the converting mechanism 401 includes one or more sliding grooves that are mounted on the rear seat 90, the axle 80, and/or other parts of the bicycle, and the auxiliary wheels 402 can move vertically in or along the sliding grooves to a desired position.

The provided auxiliary power for man-powered vehicles has the following advantages. First, the air propelling device 2 (including the guide fan assemblies 20 or the air compression devices 25) or the auxiliary device 4 is not linked with the wheels of the man-powered vehicle, e.g., bicycle. Therefore, the auxiliary power and the thrust provided by the rider can be simultaneously practiced. And the two thrusts can be practiced in any ratio. Depending on the need of individual users, the man-powered vehicle can be driven by the thrust provided from the rider, or the thrust provided by the rider combined with the auxiliary power, or the thrust entirely relying on the auxiliary power.

In a specific embodiment, the auxiliary power provided by embodiments of this invention is applied to a bicycle, and employs the air propelling device 2 shown in FIGS. 2A and 2B. Generally, the power required to drive a bicycle, i.e., the power provided by pedaling of a person, is about 200 W. If each guide fan assembly 20 has an efficiency of 30%, an input voltage of 24V, and a current of 10 A, then the auxiliary power generates power of 240 W and an effective power of 72 W, which is 36% of the pedaling power of a person required to drive the bicycle. In other words, the auxiliary power can save 36% labor. If each guide fan assembly 20 has an input voltage of 24V and a current of 20 A, then the auxiliary power generates power of 480 W11 and an effective power of 144 W, which is 72% of the pedaling power of a person. In other words, the auxiliary power can save 72% labor. If each guide fan assembly 20 has an input voltage of 24V and a current of 30 A, then the auxiliary power generates power of 720 W and an effective power of 216 W, which is more than 100% of the pedaling power of a person required to drive the bicycle. In other words, the bicycle can be driven by entirely relying on the auxiliary power.

The air propelling device 2 provided by the present invention is a novel concept. The provided thrust is irrelevant to friction between the wheels and the ground. The air propelling device 2 can cooperate with wheels to easily move the vehicle forward on the ground without worrying about the wheels slipping due to the smooth or wet ground. The auxiliary power is separated from the wheels, where the auxiliary power provides forward thrust, and the wheels provide low-friction support. Therefore, the auxiliary power provided by the present invention can be used not only in man-powered vehicles, but also in other electric vehicles or vehicles to transport cargo.

The intent accompanying this disclosure is to have each/all embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention.

Conditional language, such as, among others, “can,” “could,” “might,” or “may,” unless specifically stated otherwise, or otherwise understood within the context as used, is generally intended to convey that embodiments include, and in other interpretations do not include, certain features, elements and/or steps. Thus, such conditional language is not generally intended to imply that features, elements and/or steps are in any way required for one or more embodiments, or interpretations thereof, or that one or more embodiments necessarily include logic for deciding, with or without user input or prompting, whether these features, elements and/or steps are included or are to be performed in any particular embodiment.

Although specific embodiments have been illustrated and described, it will be appreciated by those skilled in the art that various modifications may be made without departing from the scope of the present invention, which is intended to be limited solely by the appended claims.

What is claimed is:

1. An auxiliary power for man-powered vehicles, comprising:
an air propelling device being mounted on a man-powered vehicle for discharging air toward the back of the man-powered vehicle, such that the man-powered vehicle moves forward by a reaction force of the backward-flow air; and
a control system being connected to the air propelling device through a wired or wireless manner to control the amount of air discharged by the air propelling device.

2. The auxiliary power as recited in claim 1, wherein the air propelling device comprises:
one or more guide fan assemblies; and
one or more motors corresponding to the one or more guide fan assemblies;
wherein each of the one or more guide fan assemblies comprises:
a duct; and
a propeller being arranged within the duct and being connected to the motor that corresponds to the guide fan assembly, so that the motor drives the propeller to rotate.

3. The auxiliary power as recited in claim 1, wherein the air propelling device comprises:
one or more propellers;
one or more motors corresponding to the one or more propellers, wherein each motor connects to the corresponding propeller and drives the corresponding propeller to rotate; and
one or more protective covers corresponding the one or more propellers, wherein each protective cover is configured to protect the corresponding propeller from being directly touched by the users.

4. The auxiliary power as recited in claim 1, wherein the air propelling device comprises one or more motors, and the control system comprises:
a controller providing a control signal;
a battery;
one or more electronic speed controllers (ESC) corresponding to the one or more motors, each electronic speed controller being connected to the battery, the corresponding motor, and the controller to receive the control signal and convert it into current so as to control a speed of the corresponding motor.

5. The auxiliary power as recited in claim 4, the control signal is a pulse width modulation signal.

6. The auxiliary power as recited in claim 1, wherein the air propelling device comprises one or more motors, and the control system comprises:
a remote controller provides a control signal;
a battery;
a receiver to receive the control signal in a wireless manner; and
one or more electronic speed controllers corresponding to the one or more motors, each electronic speed controller being connected to the battery, the corresponding motor, and the receiver to receive the control signal and convert it into current so as to control a speed of the corresponding motor.

7. The auxiliary power as recited in claim 1, wherein the air propelling device comprises one or more motors, and the control system comprises:
a variable resistor that outputs a voltage according to a user's operation;
a first microprocessor being connected to the variable resistor to receive the voltage and convert it into a control signal;
a wireless transmitting module being connected to the first microprocessor to transmit the control signal;
a wireless receiving module to receive the control signal;
a second microprocessor being connected to the wireless receiving module to convert the control signal into a pulse width modulation (PWM) signal;
a battery;
one or more electronic speed controllers corresponding to the one or more motors, each electronic speed controller being connected to the battery, the second microprocessor, and the corresponding motor to receive the pulse width modulation (PWM) signal and convert it into current so as to control a speed of the corresponding motor.

8. The auxiliary power as recited in claim 7, wherein the control system further comprises:
one or more sensors to detect acceleration and attitude of the man-powered vehicle, the first microprocessor outputting the control signal according to a signal of the one or more sensors.

9. The auxiliary power as recited in claim 8, wherein the one or more sensors comprise an accelerometer and a gyroscope sensor for detecting the acceleration and attitude of the man-powered vehicle, a sensor for detecting the torque and/or rotational speed of cranks of the man-powered vehicle, and a sensor for detecting obstacles.

10. The auxiliary power as recited in claim 7, wherein the first microprocessor outputs the control signal according to a voice input of a user.

11. The auxiliary power as recited in claim 1, wherein the air propelling device comprises:
one or more compressed air devices, each of which comprises:
a gas container for containing a compressed air;
an air outlet for discharging the compressed air; and
a control valve being arranged adjacent to the air outlet for controlling an amount of the discharged compressed air.

12. The auxiliary power as recited in claim 1, further comprising:
an air balancing device being arranged at a left side and a right side of the man-powered vehicle to discharge air upward or downward the man-powered vehicle, so as to balance the man-powered vehicle by controlling the amount of air discharged from the left side and the right.

13. The auxiliary power as recited in claim 12, wherein the air balancing device comprises:
a plurality of guide fan assemblies being evenly arranged at the left side and the right side of the man-powered vehicle; and
a plurality of motors corresponding to the plurality of guide fan assemblies;
wherein each guide fan assembly comprises:
a duct; and
a propeller being arranged within the duct and being connected to the motor that corresponds to the guide fan assembly, so that the motor drives the propeller to rotate.

14. The auxiliary power as recited in claim 12, wherein the air balancing device comprises:
a plurality of propellers being evenly arranged at the left side and the right side of the man-powered vehicle; and
a plurality of motors corresponding to the plurality of propellers, each motor being connected to one corresponding propeller and driving the corresponding propeller to rotate.

15. The auxiliary power as recited in claim 12, wherein the air balancing device comprises:
a plurality of compressed air devices being evenly arranged at the left side and the right side of the man-powered vehicle;
wherein each of the compressed air devices comprises:
a gas container for containing a compressed air;
an air outlet for discharging the compressed air; and
a control valve being arranged adjacent to the air outlet for controlling an amount of the discharged compressed air.

16. The auxiliary power as recited in claim 1, wherein the air propelling device provides 0% to 100% of the power required to drive the man-powered vehicle.

17. The auxiliary power as recited in claim 1, wherein the control system comprises a battery, which is charged with a solar-cell module.

18. An auxiliary power for man-powered vehicles, comprising:
an auxiliary device mounted on a man-powered vehicle, comprising:
a converting mechanism; and
a plurality of auxiliary wheels being connected to the converting mechanism, the converting mechanism selectively positioning the auxiliary wheels in contact with the ground, so that the man-powered vehicle is driven by the auxiliary wheels; and
a control system connecting with the auxiliary device in a wired or wireless manner to control a rotation speed of the auxiliary wheels.

19. The auxiliary power as recited in claim 18, wherein the converting mechanism comprises pivot ends pivoted to an axle of a rear wheel of the man-powered vehicle.

20. The auxiliary power as recited in claim 18, wherein the converting mechanism comprises one or more grooves, and the auxiliary wheels can move in the one or more grooves.
